(19) United States
(12) Patent Application Publication
(10) Pub. No.: US 2005/0076045 A1
(43) Pub. Date: Apr. 7, 2005

(54) Method and system for handling multiple dimensions in relational databases

(76) Inventors: Pal Stenslet, Frogner (NO); Odd Arild Lehne, Jar (NO); Brita Vefring Jensen, Oslo (NO)

Correspondence Address: BIRCH STEWART KOLASCH & BIRCH, PO BOX 747, FALLS CHURCH, VA, 22040-0747, US

(21) Appl. No.: 10/471,802

(22) PCT Filed: Dec. 14, 2001
(86) PCT No.: PCT/NO01/00496

Related U.S. Application Data
(60) Provisional application No. 60/333,759, filed on Nov. 29, 2001.

(30) Foreign Application Priority Data
Mar. 19, 2001 (NO) 20011395

(51) Int. Cl. G06F 17/00

(52) U.S. Cl. 707/101

(57) ABSTRACT

The invention relates to a method for structuring data in a computerized relational database system. The method includes generating a dimension type table (dim_type) of descriptions of dimensions, a dimensional item table (dim_item) of dimensional items, a location table (location) of locations type representing intersection points between the various dimensions, and a connection table (dim_conn) defining connections between each location and dimensional items with which they are associated. Preferably, the values stored in the database are entered in a separate data value table (data_value). The invention also relates to a database system with data structured in accordance with the method. The invented data structure makes it possible to achieve flexibility and reuse of code without sacrificing scalability and performance of searching and reporting. Particularly, the structure facilitates a method for building queries for generating reports focusing on a subset of the data in the database limited by various criteria simultaneously involving an arbitrary number of dimensions, and a method for retrieving the items contained in a regular dimension classified according

The present invention relates to a method for representing information structured according to multiple dimensions in a relational database system in order to achieve flexibility and reuse of code across application domains without sacrificing scalability and performance of searching and reporting. Further the invention relates to a method for building queries for generating reports focusing on a subset of the data in the database limited by various criteria simultaneously involving an arbitrary number of dimensions, and a method for retrieving the items contained in a regular dimension classified according to multiple analysis dimensions.

The invention also relates to a database system for utilizing the methods.

Many present systems for reporting on multidimensional data are based on proprietary database management systems specially designed for multidimensional data. Although this may give these systems good performance, it limits their integration ability, since data must be uploaded from the data sources into the multi-dimensional database at certain points in time. The choice of a proprietary platform also prohibits these systems from benefiting from the continuous technological progress that is being made by the vendors of the widespread relational database management systems.

Most relational databases for applications working with multiple dimensions are based on dedicated columns for each dimension. This is e.g. illustrated by a number of financial systems offering a limited number of dimensions for accounting. Each dimension is related to one or more columns in a database table, and the number of columns in the table determines the total number of dimensions the application is able to handle.

It is common that each dimension is internally structured as a hierarchy.

Hierarchical position is mainly expressed in one of three ways, either in an identity field (ID-field), such as by letting the account number of an account start with the account number of the account above it in the hierarchy, by giving each element a column identifying the element immediately above in the hierarchy, or by reserving a number of columns to hold the dimension and assign one column to each level in the hierarchy.

The method for searching for a selection of items belonging in the same branch within a hierarchical dimension differs for these three representations of the hierarchy. In the first case, a search is made for all records with a particular beginning in the ID-field. In the second case, particular extensions to the SQL query language are used, such as “connected by” in the Oracle relational database management system. In the third case, the system uses knowledge about the dimension in order to decide which columns to check for the criteria.

There are several disadvantages to these methods. The coding of the ID-field is inflexible. If the ID-field is used in an integration of two systems that otherwise are independent, there is no way to redefine the hierarchical relations in one of the systems, e.g. in order to satisfy particular reporting needs. Extensions to the query language are subject to a number of implementation limitations often making it impossible to at the same time express other limitations one might want to include in the query to the database. The method of representing a dimension by a list of columns, limits the possible depth of the hierarchy and makes it impossible to represent unbalanced hierarchies (i.e. all items at the same level in a dimension must be considered to be of the same kind).

WO 01/33427 describes a technique which address the problems associated with conventional approaches for storing multidimensional data in a relational database system. The main focus is to achieve reduced reply times of queries on star schemes in relation databases. This is obtained by reducing the physical size of the fact tables, and through forcing a particular physical organization of the rows internally in the fact tables. The characteristics of the star schema are not changed with dedicated tables for each dimension and for each fact type, as is done in the present invention.

WO 99/45479 describes a method of implementing an acyclic directed graph structure using a relational database. This is done by generating three different table structures. A node table indicates a relationship between each node in an acyclic digraph and at least one node property, an edge table indicates a relationship between each directly coupled pair of nodes in the acyclic digraph, while a path table indicates the existence of a path between any two nodes in the acyclic digraph. The resulting database is convenient when representing real world hierarchy systems. However it is only suggested to relate data items directly to nodes in the graph. It does not describe how to relate data items to several locations in several dimensions (or graphs) without changing the table containing the data items. It is possible to let one item belong to several categories by allowing any node to have more than one ancestors, but such categories can not readily be handled independently. Neither does this publication teach the creation of analysis dimensions to impose alternative perspectives on existing dimensions. Further, it does not represent the length of the path in number of hops between two nodes, and in particular it does not suggest the representation of zero-length paths which facilitates selection of sub-trees.

The present invention describes a method for implementing a multipurpose representation of multidimensional data in a relational database system. The invented method of organizing the data is capable of representing data from a large array of different real-world domains without any prior assumptions about the number of dimensions into which the data will be classified.

Dimensions in this sense refers to the various independent, possibly hierarchically structured, classification systems that may simultaneously be applied to the same or related data items.

It is often desirable to focus on a subset of the data in a database defined by various criteria that involve several different dimensions. It may also be desirable to add new dimensions and relate already existing data to these. Sometimes the addition of new dimensions are only of value in relation to specific queries, and not as an extension to the modeling of the real-world phenomena underlying the database. In this case it would be of advantage to add new dimensions for reporting purposes and apply these to perform focusing and aggregated reporting.

Code reuse in programs accessing databases are usually limited by the fact that the code contains explicit references to database tables and columns that correspond closely to entities in the application domain, such as accounts, departments and employees. The introduction of a data model that can be reused across application domains greatly increases the potential for code reuse. This in turn reduces the cost of implementing systems within a new application domain, and improves the quality of the systems by building on a thoroughly tested and optimized common code base.

The performance of queries supporting aggregated reporting in relational databases typically decreases severely as the number of tables involved increases, or as the size of the tables involved increases. There are different strategies to attack this problem. One options is to calculate pre-aggregated values at the hierarchical levels where reporting is presumed to be desired. This is however a time-consuming process, especially if the number of dimensions is large, and it is only successful if the user's reporting requirements can be predicted in advance. Another option is to limit the size of the tables, by holding each dimension in a separate table, and possibly each type of application data in a separate table. However, this reduces the potential for code reuse, which usually increases the lifetime costs of the system.

By using the invented method of organizing multi-dimensional data in a relational database it is possible to implement a system that appears to have built-in knowledge about the entities of a specific application domain, but where the actual program code references only a small number of tables and columns representing generic entities. The general nature of the tables suggests that the number of rows of some of the tables will be large, and that the performance of queries supporting aggregated reporting will suffer. A method to overcome this potential problem is described. It makes it possible to focus on data subsets in a very efficient manner that reduces the time it takes to generate reports, particularly if the specification of the focus is complex, involving a large number of dimensions. It is further possible to perform efficient aggregated reporting on such subsets without the need to rely on pre-aggregated data. This efficiently enhances the speed at which computerized searches in relational databases can be performed and increases the flexibility and power of such computerized searches.

An embodiment of the invention provides a method for structuring data in a computerized relational database system. According to the invention the method includes steps for generating tables that describe the various dimensions present in the database, the items belonging to these dimensions, the locations representing intersection points between the various dimensions, and the connections that relate these locations to the dimensional items with which they are associated.

This structure provides the framework for constructing a multidimensional database. Often the items of one or more dimensions will be hierarchical, and if such hierarchical relationships are present, these are preferable expressed by introducing a hierarchy table that defines the relationship with all pairs of items in a dimension by referring to one item as an ancestor and the other item as a descendant and giving the number of hierarchical levels as a distance between the two items. To facilitate the selection of sub-trees, each item is its own ancestor with distance zero.

According to a preferred embodiment the invention further includes steps for generating a table of data values, such as numeric or alphanumeric values. Each entry in this data value table is associated with a location in the location table mentioned above. Alternatively, if the database is of such a nature that there will only be one data value associated with each intersection of dimensions, these values could be entered directly in the location table. Another alternative would be to include several locations referring to the same set of dimensional items.

According to preferred embodiments the invention also includes steps for generating a table that defines item types, a table that defines connection types and a table that defines location types. These tables define various classifications and semantics related to entries in other tables, and they can be used in order to specify queries in the database, or to enforce rules restricting the possible structures that can be represented in the other tables.

Another embodiment of the invention provides a database system with tables generated in accordance with the method described above. Such a database will provide a great extent of flexibility and allow reuse of code without loss of efficiency when performing queries.

According to one embodiment of the invention there is provided a method for performing a query in a database substantially structured as outlined above. According to this embodiment, a query focus specification defines the subset of the database that the query should retrieve its results from. Based on this specification a working table is generated defining a query focus, and the query is the performed according to the focus defined in this table.

According to a preferred embodiment of this method, a second working table is generated defining the groups that the data resulting from the query should be aggregated by.

Another aspect of the invention provides a method for generating analysis dimensions. These dimensions are dimensions that rather than defining regular dimensions with items associated with data values, define items that are associated with items in the regular dimensions. Items contained in a regular dimension can be structured according to multiple analysis dimensions. Analysis dimensions can for instance be used to specify queries, particularly queries that involve sub-sets of dimensions where the items belonging to a sub-set are scattered throughout a dimension (e.g. not co-located for instance within the same sub-tree). They can also be used to specify aggregation of query results into groups that are not explicitly expressed as items in the regular dimension, or they can be used to navigate the database, giving alternative perspectives for accessing particular items or data values of the database. Finally, by using a dedicated connection type, a regular dimension may take on the role of an analysis dimension towards another regular dimension.

The invention also includes computer programs comprising instructions for causing a computer to perform the methods outlined above. These computer programs may be embodied on a record medium such as a CD ROM, stored in a computer memory, carried on optical or electrical carrier signals, or represented in another computer accessible format.

The particular steps and features of the methods and computer database systems according to the invention are put forth in the independent claims, with additional features and embodiments outlined in the dependent claims.

The invention will now be described by way of examples, with reference to the attached drawings. These show:

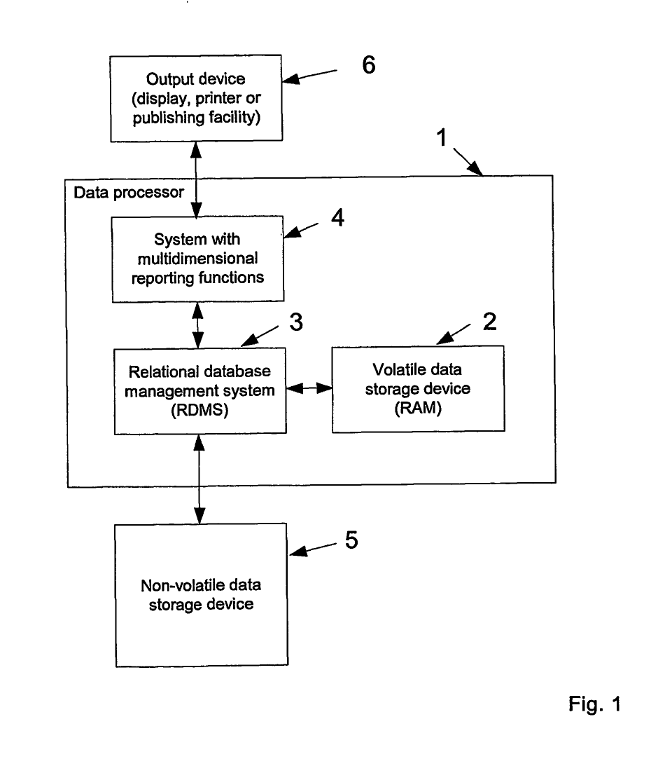

FIG. 1 A block diagram of a computerized database system implementing the invention

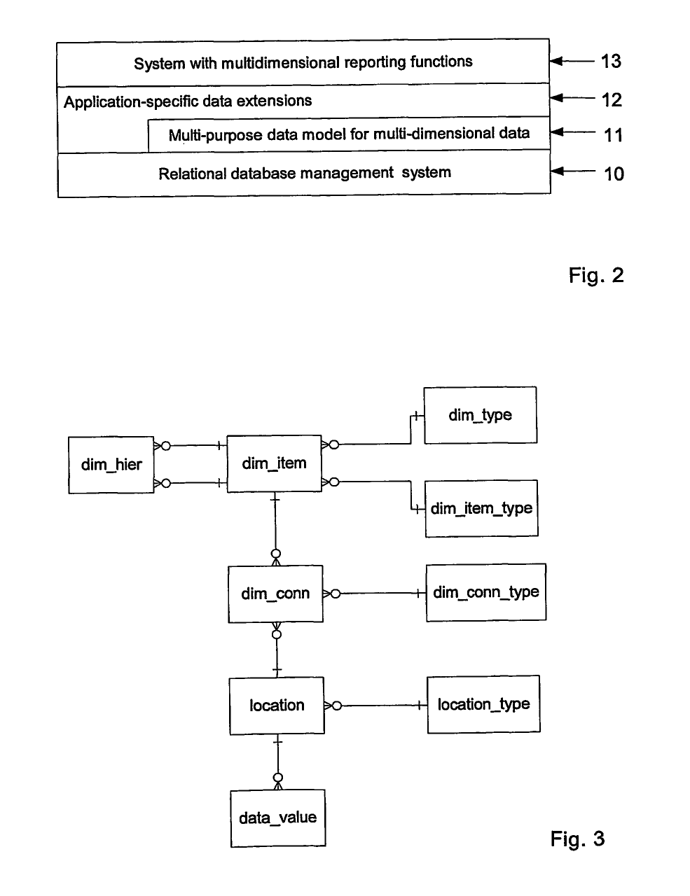

FIG. 2 An illustration of the layers of the architecture of a system operating according to the present invention

FIG. 3 Entity-Relationship diagram of a preferred embodiment of the invention

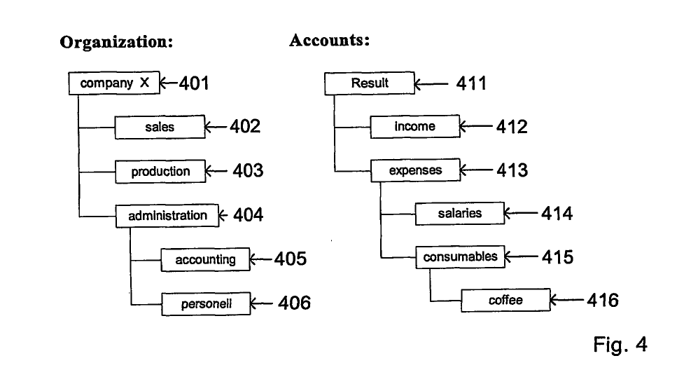

FIG. 4 A diagram illustrating two dimensions of an accounting system

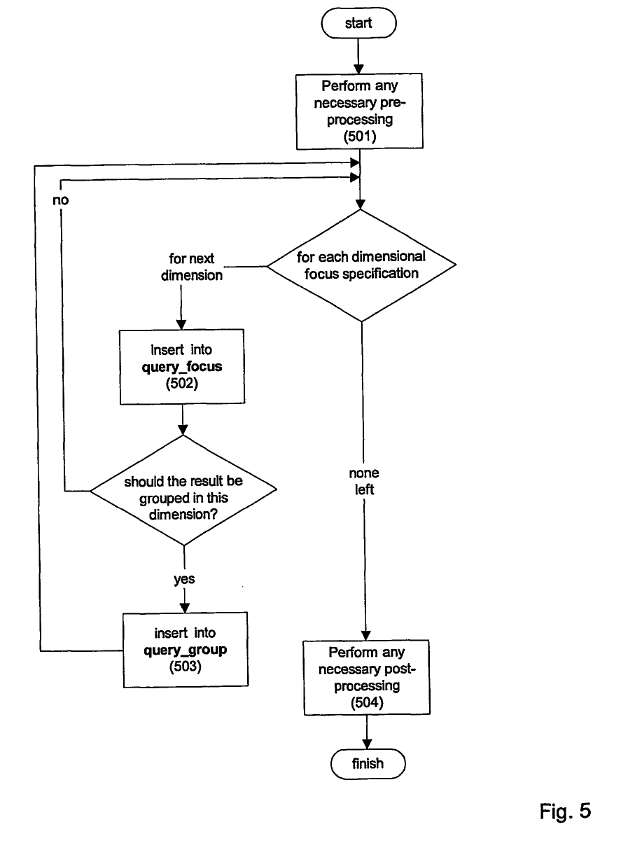

FIG. 5 A flow chart illustrating the steps of building working tables as part of performing a database query

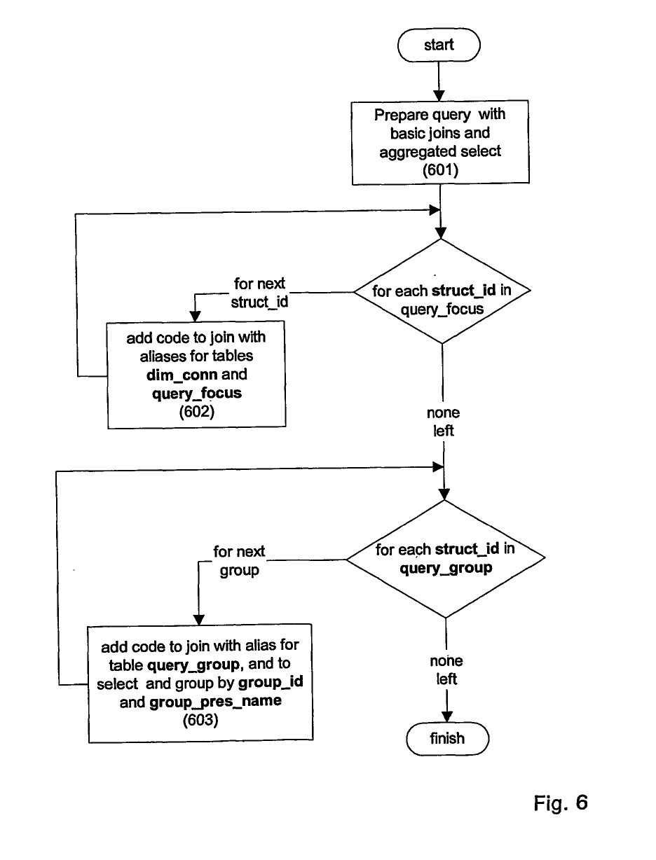

FIG. 6 A flow chart illustrating the steps for generating the code for an actual query

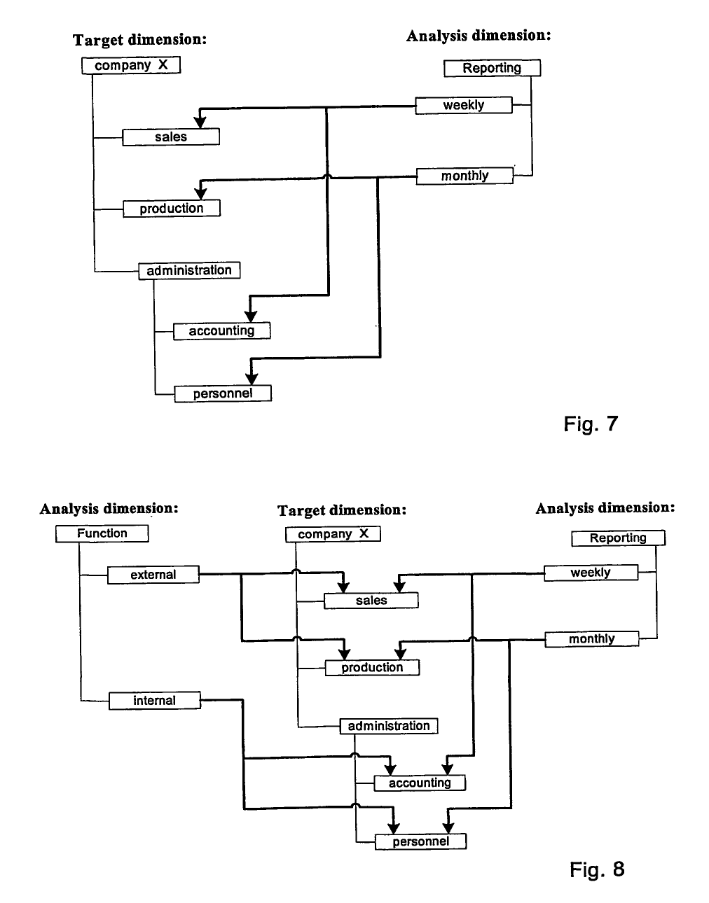

FIG. 7 A diagram illustrating the relationship between an analysis dimension and a regular dimension

FIG. 8 A diagram illustrating the relationship between two analysis dimensions and a regular dimension

FIG. 1 illustrates in a block diagram, the main components of a computerized database system on which the invention is implemented. The system comprises a central data processor 1 in communication with a volatile data storage (RAM) 2. The processor operates according to computer program instructions implementing a relational database management system (RDMS) 3, making it capable of accessing and handling data stored in a relational database on a non-volatile data storage device 5, such as one or more hard disks, a RAID (Redundant Array of Inexpensive Disks) system or some other form of suitable data storage. The relational database comprises a number of tables created in accordance with the present invention.

The processor 1 is also controlled by computer program instructions implementing a system containing functions for multidimensional reporting 4 which makes it capable of handling queries and generating reports in accordance with the present invention. Reports generated by this system 4 are transferred to an output device 6, such as a display, a printer or a publishing facility, such as a server for the world wide web.

Reference is now made to FIG. 2, which illustrates the architectural layers of a relational database system operating in accordance with the present invention. The first layer is the relational database management system 10, which may be any of a number of commercially available systems. Such systems are delivered by Oracle Corp., Microsoft Corp., IBM Corp. and others. The database management system 10 could also be developed particularly for the database in question. The only limitation is that it is able to handle relational tables and queries in such tables.

The next level is the multipurpose data model for multidimensional data 11. This is the definition of the tables and their relationships according to the invention, as well as code acting on these tables. On top of this data model, certain application-specific extensions 12 may exist. These extensions may be built on the data model according to the invention, but they may also exist in parallel and be independent extensions.

On top of the data model layers 11, 12 there is an application containing functions for multidimensional reporting 13 which is able to handle the data and generate reports. This application may also serve other purposes apart from reporting.

FIG. 3 is an Entity-Relationship diagram (ER-diagram) illustrating a preferred embodiment of the data model of the invention. In the preferred embodiment the database comprises nine different tables that will be described below, but not all of these are strictly necessary in order to achieve the most important benefits of the invention.

A dimension in a relational database according to the invention is a collection of inter-related items. Such an item will be referred to as a dimensional item. An arbitrary number of dimensions may be present in the database, and various data items may be associated with different items in the various dimensions. Special support is provided for hierarchical dimensions. A hierarchical dimension will constitute a directed graph where any node is directly connected to one ancestor node (except for the root node in the graph, which has no ancestor) and any number of descendant nodes.

As an example, consider a database of equipment, parts and tools. One dimension may classify items according to material, such as synthetics and metal (including sub-categories such as alloys, steel, etc.), while another dimension classifies parts according to usage, such as ventilation, fastening, electrical equipment, pipes and ducts, and so on. It will be readily seen that any particular item's position in one dimension, such as material, is in principle independent of its position in another dimension. A pipe may be made of metal or of a synthetic, and a part made of a particular alloy may be a fastener or a duct.

In the following description it should be noted that the various names that are used for the different columns in the various tables are local to the table, and in accordance with standard database notation the same name may be used in several tables, e.g. when an identifier in one table always refers to an identifier in another table. Below this is the case e.g. with the location identifier (location_id) of the connection table (dim_conn) which always refers to a location identifier (location_id) of the location (location) table.

The tables described below will be generated in accordance with the method according to the invention, preferably as the result of inputting the relevant information into a computer operating under control of a computer program that makes it capable of performing the invention.

A table referred to as the dimension type table (dim_type) will contain descriptions of the dimensions present in the multi-dimensional data. As a minimum, each row will contain a dimension identifier (dim_type_id) and a dimension name (dim_type_name). It may optionally be used to hold the item identifier (dim_item_id) of the item at the root of the dimension, provided the dimension is hierarchical.

The various dimensional items in a database organized in accordance with the invention will all be stored in one table referred to as the dimensional item table (dim_item). In this table the descriptions of the items contained in the dimensions are stored. As a minimum, each row of this table will contain an internal item identifier (dim_item_id), a presentation name (dim_item_name) and an identifier of a dimensional type (dim_type_id) of a dimensional type in the dimension type table (dim_type). It may optionally contain an external item identifier (dim_item_ext_id) to identify a real-world phenomenon that corresponds to the item. An example of such a phenomenon could be an account in a financial system that is being used as an external data source.

If one or more dimensions are hierarchical, the hierarchical relations between the items contained in hierarchical dimensions are stored in a table referred to as the dimensional hierarchy table (dim_hier). As a minimum, each row of this table will contain two identifiers of dimensional items in the dimensional item table (dim_item), an ancestor item (super_dim_item_id), and a descendant item (sub_dim_item_name), and the distance (distance) in number of levels between the two items. Thus, the table holds all direct and indirect relations between items belonging to the same dimensions. To facilitate selection of a sub-tree based solely on the identifier of the ancestor item (super_dim_item_id), all items are represented as their own ancestor with zero distance.

According to a preferred embodiment of the invention an additional table referred to as the dimensional item type table (dim_item_type) contains descriptions of types that may optionally be used to classify items belonging to the same dimension. As a minimum, each row will contain an item type identifier (dim_item_type_id) and an item type name (dim_item_type_name). This may be used to narrow searches, or to express rules restricting the use of the items. An example of such a rule, could be an item type that is only allowed at the leaves in a dimension tree. (E.g. in an organizational structure consisting of departments and employees, the employees may not be allowed to have any descendants.) If this table is present in the database, each row of the dimensional item table (dim_item) will contain an additional field with an identifier (dim_item_type_id) of a dimensional item type in the dimension item type table (dim_item_type).

All the currently used intersection points between the various dimensions in the model are stored in a location table (location). In a preferred embodiment, there is only one entry in this table for each such intersection for any given purpose. Data items associated with any such location are stored in a separate table for data values (data_value) described below. According to this preferred embodiment each row of the data value table (data_value) will, as a minimum, contain the identifier of the location (location_id). New rows are added to the location table (location) each time a new combination of items is used to describe where certain data belongs in the multi-dimensional space. This may for example occur when new data is imported from an external data source.

Alternatively there is one entry in the location table for each data item, which means that there may be a plurality of locations referring to the same combination of dimensional items. In this case the data values may be included in the entry in the location table or stored in a separate data value table (data_value) as described below.

According to a preferred embodiment of the invention, an additional table referred to as the location type table (location_type) contains definitions that classify the locations into different purposes. As a minimum, each row of this table will contain a location type identifier (location_type_id) and a location type name (location_type_name). If this table is present in the database, each row of the location table (location) will contain an additional field with an identifier (location_type_id) of a location type in the location type table (location_type). The location type may be used in the interpretation of associated data values, and to narrow searches for data limited to a specific purpose. Examples of purposes could be accounting data and production data in a system integrating data extracted from both a financial system and a production-tracking system.

The connections between locations and the items to which they are connected are stored in a connection table (dim_conn). As a minimum, each row will contain a location identifier (location_id) and a dimensional item identifier (dim_item_id). For any given entry in the location table (location) there will be a number of entries in the connection table (dim_conn) relating the location to any dimensional items with which it is associated.

A preferred embodiment of the invention includes an additional table referred to as the connection type table (dim_conn_type). This table defines the different semantics that may be associated with a connection between a location and a dimensional item. As a minimum, each row will contain a connection type identifier (dim_conn_type_id) and a connection type name (dim_conn_type_name). Additional rules applying to the connection types may be specified. An example of such a rule could be that locations representing financial data must be connected to one and only one item belonging to the account dimension.

If the connection type table (dim_conn_type) is present in the database, each row of the connection table (dim_conn) will include an additional entry referring to an entry in the connection type table (dim_conn_type_id) defining the type of the connection. This specifies the semantics of the connection, as described above. A location may be connected to several items of the same dimension, and it may be connected several times to the same item with different semantics for each connection.

A preferred embodiment of the invention includes an additional table referred to as the data value table (data_value). This table holds data items associated with the various locations. Each row of the data value table (data_value) will, as a minimum, contain the identifier of the location (location_id). Other fields that may be found in this table are unit of measure, identification of the period of time the value applies to, and possibly an identification of the data set the value belongs to (in the case where the model is used to hold several, comparable versions of the data, e.g. forecasted and actual values).

Reference is now made to FIG. 4, where a diagram illustrates two dimensions associated with accounting data. The two dimensions include an organization structure and an account structure. The organization structure starts with Company X 401, below which we find sales 402, production 403 and administration 404. Below administration 404 we find accounting 405 and personnel 406. The accounts are organized with result 411 at the root, below which we find income 412 and expenses 413. Expenses 413 are subdivided into salaries 414 and consumables 415, and below consumables 415 we find coffee 416.

According to this example the following figures are from the years 2000 and 2001.

| Org. unit | Account | Year 2000 | Year 2001 |
|---|---|---|---|
| sales | income | −10000000 | −12000000 |
| sales | salaries | 4000000 | 4500000 |
| sales | coffee | 3000 | 2800 |
| production | income | −3000000 | −3000000 |
| production | salaries | 7000000 | 7000000 |
| production | coffee | 10000 | 13000 |
| accounting | income | −500000 | −350000 |
| accounting | salaries | 900000 | 1100000 |
| accounting | coffee | 500 | 600 |
| personnel | income | 0 | 0 |
| personnel | salaries | 400000 | 300000 |
| personnel | coffee | 600 | 700 |

Including all the tables described above in this example, but keeping the number of columns to a minimum, the following tables are arrived at:

Table dim_item

| dim_item_id | dim_item_name | dim_type_id | dim_item_type_id |
|---|---|---|---|
| 1001 | Company X | O | S |
| 1002 | sales | O | V |
| 1003 | production | O | V |
| 1004 | administration | O | S |
| 1005 | accounting | O | V |
| 1006 | personell | O | V |
| 2001 | Result | A | S |
| 2002 | income | A | V |
| 2003 | expenses | A | S |
| 2004 | salaries | A | V |
| 2005 | consumables | A | V |
| 2006 | coffee | A | V |

Table dim_type

| dim_type_id | dim_type_name |
|---|---|
| O | Organization |
| A | Accounts |

Table dim_hi r

| super_dim_item_id | sub_dim_item_id | distance |
|---|---|---|
| 1001 | 1001 | 0 |
| 1001 | 1002 | 1 |
| 1001 | 1003 | 1 |
| 1001 | 1004 | 1 |
| 1001 | 1005 | 2 |
| 1001 | 1006 | 2 |
| 1002 | 1002 | 0 |
| 1003 | 1003 | 0 |
| 1004 | 1004 | 0 |
| 1004 | 1005 | 1 |
| 1004 | 1006 | 1 |
| 1005 | 1005 | 0 |
| 1006 | 1006 | 0 |
| 2001 | 201 | 0 |
| 2001 | 2002 | 1 |
| 2001 | 2003 | 1 |
| 2001 | 2004 | 2 |
| 2001 | 2005 | 2 |
| 2001 | 2006 | 3 |
| 2002 | 2002 | 0 |
| 2003 | 2003 | 0 |
| 2003 | 2004 | 1 |
| 2003 | 2005 | 1 |
| 2003 | 2006 | 2 |
| 2004 | 2004 | 0 |
| 2005 | 2005 | 0 |
| 2005 | 2006 | 1 |
| 2006 | 2006 | 0 |

These three tables define the graphs of the two dimensions as illustrated in FIG. 4, including the dimensional types and the hierarchical relationship between the items. Further information can be found in the dimensional item type table (dim_item_type). In this example, the dimensional item type table (dim_item_type) holds information on whether any particular item in a dimension is a value holding item or a structure item.

Table dim_item_type

| dim_item_type_id | dim_item_type_name |
|---|---|
| S | Structure item |
| V | Value-holding item |

The next table is the location table. From the specification of the example it can be seen that twelve different locations are needed, as there are currently twelve intersections between the two dimensions that are in use. That gives the following table:

Table location

| location_id | location_type_id |
|---|---|
| 10001 | LA |
| 10002 | LA |
| 10003 | LA |
| 10004 | LA |
| 10005 | LA |
| 10006 | LA |
| 10007 | LA |
| 10008 | LA |
| 10009 | LA |
| 10010 | LA |
| 10011 | LA |
| 10012 | LA |

Since all information in this example is accounting information, the location type table (location_type) will be very short. Similarly, since there are only one type of connections, the connection type table (dim_conn_type) will include only one entry.

Table location_type

| location_type_id | location_type_name |
|---|---|
| LA | Accounting information |

Table dim_conn_type

| dim_conn_type_id | dim_conn_type_name |
|---|---|
| D | Default |

The connection table defines the relationships between the locations and the dimensional items. Note that according to this example, each location is connected with one item in each dimension. This is, however, not a limitation of the invention, but it is typical of an accounting system that an amount should be associated with a single organizational unit and a single account.

Table dim_conn

| location_id | dim_item_id | dim_conn_type_id |
|---|---|---|
| 10001 | 1002 | D |
| 10002 | 1002 | D |
| 10003 | 1002 | D |
| 10004 | 1003 | D |
| 10005 | 1003 | D |
| 10006 | 1003 | D |
| 10007 | 1005 | D |
| 10008 | 1005 | D |
| 10009 | 1005 | D |
| 10010 | 1006 | D |
| 10011 | 1006 | D |
| 10012 | 1006 | D |
| 10001 | 2002 | D |
| 10002 | 2004 | D |
| 10003 | 2006 | D |
| 10004 | 2002 | D |
| 10005 | 2004 | D |
| 10006 | 2006 | D |
| 10007 | 2002 | D |
| 10008 | 2004 | D |
| 10009 | 2006 | D |
| 10010 | 2002 | D |
| 10011 | 2004 | D |
| 10012 | 2006 | D |

Finally the actual values are stored in the data value table (data_value). The data value table refers to a location in the location table, and in this way the value is associated with an item in each dimension. In addition the data value table includes a time period associated with each value. In a similar way this table may include fields specifying unit of measure or other information about the data that is not defined by the location or dimensions with which it is associated.

Table data_value

| location_id | data_value | time_period |
|---|---|---|
| 10001 | −10000000 | 2000 |
| 10002 | 4000000 | 2000 |
| 10003 | 3000 | 2000 |
| 10004 | −3000000 | 2000 |
| 10005 | 7000000 | 2000 |
| 10006 | 10000 | 2000 |
| 10007 | −500000 | 2000 |
| 10008 | 900000 | 2000 |
| 10009 | 500 | 2000 |
| 10010 | 0 | 2000 |
| 10011 | 400000 | 2000 |
| 10012 | 600 | 2000 |
| 10001 | −12000000 | 2001 |
| 10002 | 4500000 | 2001 |
| 10003 | 2800 | 2001 |
| 10004 | −3000000 | 2001 |
| 10005 | 7000000 | 2001 |
| 10006 | 13000 | 2001 |
| 10007 | −350000 | 2001 |
| 10008 | 1100000 | 2001 |
| 10009 | 600 | 2001 |
| 10010 | 0 | 2001 |
| 10011 | 300000 | 2001 |
| 10012 | 700 | 2001 |

It should be noted that this example, with a single location type (location_type), does not utilize the full potential of the model. Extending the example with a new dimension called Activities, holding projects and tasks would involve adding rows to the following tables: In the dimensional type table (dim_type), a row should be added to represent the new dimension Activities. In the dimensional item type table (dim_item_type), two rows representing project and task should be added. The dimensional item table (dim_item) should be extended by the addition of rows representing each one of the different projects and tasks. Finally, the dimensional hierarchy table (dim_hier) should have rows added to represent the hierarchical relations between the projects and tasks.

Consider the example where a plan shall be created allocating the workforce within each organizational unit to specific tasks. To accomplish this, a new location type to represent workforce allocation, is defined. Each organizational unit will need one location for each task its workforce is allocated to. This will involve adding rows to the following tables: In the location type table (location_type), a row should be added to represent workforce allocation. In the location table (location) one row should be added for each combination of organizational unit and task where workforce will be allocated. The connection table (dim_conn) should be extended by the addition of rows connecting the new locations to the dimensional items in the dimensional item table (dim_item) for their corresponding organizational units and tasks. In the data value table (data_value), rows are added to hold the actual amounts allocated. Several rows may be added for each location in the location table (location), e.g. to represent a distribution into several periods of time. In other words, all this is possible without changing the format of any of the tables involved.

Furthermore, a database structured according to the invention can be queried for data in a number of ways. In order to utilize the full potential for reuse of program code, the programs operating on the model should work regardless of the number of dimensions involved. This implies that the queries must be generated dynamically. The following examples are illustrated through use of the standard query language SQL, but this is not a limitation of the invention.

The following information may be involved in the specification of a request for an aggregated report: Focus in one or more dimensions including lists of explicitly selected items from each dimension, a specification on the generality of the focus (e.g. whether items in the sub-trees of the selected items should be considered to be within focus), and connection types and/or item types to consider when searching for locations connected to items that are within focus. The request may also specify location types corresponding to the purpose of the data of interest. As mentioned above, the data value table (data_value) may include implementation dependent columns such as period of time or unit of measure, and the request may include restrictions with respect to these. Furthermore, the method of aggregation for the data of interest should be specified (possibly deduced from specified units of measure), as well as which dimensions the aggregated result should be grouped according to. For the dimensions where a focus has been specified, grouping at the explicitly selected items are often desired. When grouping is specified for a non-focused dimension, the aggregated data will be grouped by the dimensional items at the actual location of the data.

In the descriptions that follow the term ‘dimensional focus specification’ will be used to designate a specification that limits the scope of a query to a subset of the items belonging to a single dimension. The term ‘query focus specification’ will be used to designate a collection of dimensional focus specifications. The term ‘explicitly selected item’ will be used to designate the dimensional items that a dimensional focus specification starts with. These could for instance be items selected by a user through the user interface of a reporting application. The term ‘focused item’ will be used to designate the dimensional items that potentially reference locations for data to be included in the result of the query. The set of focused items will depend on which items are explicitly selected, the internal organization of the dimension, and the generality of the dimensional focus specification. For a hierarchical dimension, a typical specification of generality is to include all items descendant to the explicitly selected items. The explicitly selected item that caused a certain item to be considered a focused item, will be referred to as the ‘focus-enabling item’ of the focused item.

Note that the same dimension may be used in several dimensional focus specifications within the same query focus specification, and that these may specify additional limitation with respect to e.g. dimensional item type (dim_item_type) or connection type (dim_conn_type) making them semantically different.

An example of a non-hierarchical dimension could be a graph representing a railway system with each station represented as a dimensional item. Additional implementation dependent tables could be used to represent the distance between the stations. An example of a dimensional focus specification in such a dimension could be the explicit selection of a dimensional item representing the station ‘Sometown’, specifying that all stations within a distance of 100 kilometers should be within focus. The set of focused items would then be the dimensional items representing the stations within a distance of 100 kilometers from ‘Sometown’.

In the following example the items <sales, production, administration> and <income, expenses> have been selected from the two dimensions Organization and Accounts described above. All descendant items are considered to be within focus. The result should be aggregated using the SUM( )-function and be grouped by the selected items in both dimensions. For the sake of clarity, restrictions that do not involve the treatment of dimensions are left out in the following description.

Different strategies may be applied when generating SQL code for such queries.

One obvious option is to use one set of alias names for the tables dim_conn, dim_hier and dim_item for each dimensional focus specification:

/* ID and Name of selected organizational unit: */

O_dim_item.dim_item_id, O_dim_item.dim_item_name,
/* ID and Name of selected account: */
A_dim_item.dim_item_id, A_dim_item.dim_item_name,
/* Total of accounting data */
SUM(data_value.data_value)

FROM

data_value, location,
/* Table aliases for specification of focus in the organization dimension: */
dim_item O_dim_item, dim_hier O_dim_hier, dim_conn O_dim_conn,
/* Table aliases for specification of focus in the account dimension: */
dim_item A_dim_item, dim_hier A_dim_hier, dim_conn A_dim_conn

WHERE

location.location_id = data_value.location_id
AND /* Specification of focus on <sales,production,administration> including descendants: */

(O_dim_item.dim_item_id IN (1002, 1003, 1004) AND
O_dim_item.dim_item_id = O_dim_hier.super_dim_item_id AND
O_dim_conn.dim_item_id = O_dim_hier.sub_dim_item_id AND
O_dim_conn.location_id = location.location_id)

AND /* Specification of focus on <income,expences> including descendants: */

(A_dim_item.dim_item_id IN (2002, 2003) AND
A_dim_item.dim_item_id = A_dim_hier.super_dim_item_id AND
A_dim_conn.dim_item_id = A_dim_hier.sub_dim_item_id AND
A_dim_conn.location_id = location.location_id)

GROUP BY

/* Calculate totals per combination of selected org. unit and account: */
O_dim_item.dim_item_id, O_dim_item.dim_item_name,
A_dim_item.dim_item_id, A_dim_item.dim_item_name

Although this solution may work well for one or two dimensions, it does not scale as the number of dimensions involved increases, or when the number of rows in the tables increases. The invention therefore includes a method for performing queries in a database organized according to the invention, said method taking advantage of the flexibility of the data structure described above.

By introducing two working tables where the information about focusing and grouping is prepared prior to running the query, huge performance gains can be made.

The working tables can either be predefined for each user querying the database, or they may be created on demand. The scheme used to provide the necessary storage for query preparation is implementation dependent. It is required that the scheme chosen ensures that no conflicts arise from two simultaneous queries accessing the same storage for query preparation.

When a query focus specification has been specified (e.g. by means of an interactive user interface), defining the subset of the database that the query should retrieve its results from, the first working table is generated. The first working table is referred to as the query focus table (query_focus). The query focus specification consists of a list of dimensional focus specifications, each specifying rules to identify a subset of dimensional items from one dimension of the database.

The query focus table will be generated as explained in the example below to include a list of focused items. Following the generation of the query focus table the query may be performed based on the focus defined in the query focus table, collecting data associated with locations connected to at least one of the focused items identified for each focus specification contained in the query focus specification.

In order to aggregate the results according to the explicitly selected items or some categorization of these, creating the query focus specification may include specifying, for any given dimensional focus specification, rules to directly or indirectly retrieve a list of explicitly selected item identifiers. The query focus table will then be extended to include in each row the identifier of a selected item, which means the explicitly selected item that caused the focused item of that row to be considered part of the focus. Following this a second working table may be generated as explained below to define groups that the query result should be aggregated by. The second working table is referred to as the query group table (query_group). Each row of the query group table will indicate which group a selected item identifier originating from a given dimensional focus specification belongs in.

Further alternatives and details related to the use of working tables will be made clear in the following example.

For the sake of clarity, an example is used where the working tables are ordinary database tables that are private to the user, and where the user has the necessary privileges to manipulate their contents. The working tables are described below:

The first working table lists all the focused items, along with their focus-enabling items (i.e. the explicitly selected item that caused the focused item to be considered within focus). This query focus table (query_focus) contains the following columns:

The structural identity column (struct_id) identifies which dimensional focus specification the row belongs to. The value may simply be the dimensional type identifier (dim_type_id) of the corresponding dimension, but it may also be synthesized from other values (e.g the dimensional type identifier (dim_type_id) and the connection type identifier (dim_conn_type_id) in cases where the same dimension is used to express more than one dimensional focus specification depending on the connection type).

The focused item identifier (focus_dim_item_id) column identifies a focused item.

The selected item identifier (sel_dim_item_id) identifies the focus-enabling item of the focused item (focus_dim_item_id).

The second working table, the query group table (query_group), indicates how the data connected to focused items should be grouped (as rows with aggregated values) in the query result. There are several options that may be applied individually for each dimensional focus specification: No grouping, one group per explicitly selected item, or several explicitly selected items collected into each group. In the first case there will be no rows in the query group table (query_group) relating to that dimensional focus specification. The query group table (query_group) contains the following columns:

Two columns, the structural identity column (struct_id) and the selected item identifier column (sel_dim_item_id), identifies the rows in the query focus table (query_focus) that should be grouped by this group (group_id).

The group identifier (group_id) identifies the group. The value may simply be the selected item identifier (sel_dim_item_id) of the same row, but it may also be synthesized from other values, e.g if the list of selected item identifiers (sel_dim_item_id) was derived by applying some other search criteria. An example of this will be described further below.

Group presentation name (group_pres_name) is the name that will be used when presenting the group in the result of the aggregated query. Note that this name alone is not considered as sufficient to form a GROUP BY clause, as the textual representation of items from different dimensions may coincide. The presentation name may optionally be split into several columns to support separation of various informations to be presented for each group, for instance ‘full name’ and ‘abbreviated name’. For the sake of clarity, a single presentation name (group_pres_name) is used in the following description.

A dimensional focus specification may be used solely to limit the scope of a query, without specifying that the results should be grouped by the explicitly selected items. In such a case the processing of the dimensional focus specification will only insert rows into the query focus table (query_focus), leaving the query group table (query_group) unchanged. In such a case it may not be necessary to retain information in the query focus table (query_focus) about the explicitly selected items.

Reference is now made to FIG. 5, which is a diagram illustrating the process of building these two tables based on a query focus specification. In a first step 501 any necessary pre-processing is performed. Following that, each dimensional focus specification is processed to determine the set of focused items, and each focused item are entered 502 into the query focus table (query_focus) along with its focus-enabling item. If the result should be aggregated according to the current dimensional focus specification, the explicitly selected items will be entered 503 into the query group table (query_group) along with an identification of the group they should be aggregated into. When all the dimensional focus specifications have been processed in this manner, any necessary post-processing is performed 504.

The following SQL statements will result in the relevant query and group tables for the example above.

/* Perform any necessary pre-processing (501): */
TRUNCATE TABLE query_focus;
TRUNCATE TABLE query_group;
/* Insert rows into query_focus to indicate focus on <sales,production,administration> including
descendants (502): */
INSERT INTO query_focus (struct_id, sel_dim_item_id, focus_dim_item_id)
SELECT ‘O’, dim_hier.super_dim_item_id, dim_hier.sub_dim_item_id
FROM dim_hier
WHERE dim_hier.super_dim_item_id IN (1002, 1003, 1004);
/* Insert rows into query_group to indicate aggregation of values per selected org. unit (503): */
INSERT INTO query_group (struct_id, sel_dim_item_id, group_id, group_pres_name)
SELECT ‘O’, dim_item.dim_item_id, dim_item.dim_item_id, dim_item.dim_item_name
FROM dim_item
WHERE dim_item.dim_item_id IN (1002, 1003, 1004);
/* Insert rows into query_focus to indicate focus on <income,expenses> including descendants (502): */
INSERT INTO query_focus (struct_id, sel_dim_item_id, focus_dim_item_id)
SELECT ‘A’, dim_hier.super_dim_item_id, dim_hier.sub_dim_item_id
FROM dim_hier
WHERE dim_hier.super_dim_item_id IN (2002, 2003);
/* Insert rows into query_group to indicate aggregation of values per selected account (503): */
INSERT INTO query_group (struct_id, sel_dim_item_id, group_id, group_pres_name)
SELECT A, dim_item.dim_item_id, dim_item.dim_item_id, dim_item.dim_item_name
FROM dim_item
WHERE dim_item.dim_item_id IN (2002, 2003);
/* Perform any necessary post-processing (504): */
ANALYZE TABLE query_focus COMPUTE STATISTICS;
ANALYZE TABLE query_group COMPUTE STATISTICS;

The pre-processing is implementation dependent and may vary based on scheme used to provide the necessary storage for query preparation. The statements shown here are appropriate when private tables are used, and show how the tables are emptied of any contents from previous queries.

The post-processing is implementation dependent and may vary based on the actual relational database management system being used. The statements shown here are appropriate when using an Oracle database with the default cost-based query optimizer.

The code shown in the example for step 502 applies to hierarchical dimensions. For non-hierarchical dimensions the code will be replaced by code joining with implementation dependent tables in order to express the generality indicated in the dimensional focus specification.

The sequence of statements above will result in two tables with the following content:

Table query_focus

| struct_id | sel_dim_item_id | focus_dim_item_id |
|---|---|---|
| O | 1002 | 1002 |
| O | 1003 | 1003 |
| O | 1004 | 1004 |
| O | 1004 | 1005 |
| O | 1004 | 1006 |
| A | 2002 | 2002 |
| A | 2003 | 2003 |
| A | 2003 | 2004 |
| A | 2003 | 2005 |
| A | 2003 | 2006 |

Table query_group

| struct_id | sel_dim_item_id | group_id | group_pres_name |
|---|---|---|---|
| O | 1002 | 1002 | sales |
| O | 1003 | 1003 | production |
| O | 1004 | 1004 | administration |
| A | 2002 | 2002 | income |
| A | 2003 | 2003 | expenses |

Reference is now made to FIG. 6, which shows a diagram illustrating the generation of the code for the actual query.

In a first step 601 a query is prepared with basic joins and aggregated select. Following that, for each focused dimension (i.e. for each structural identity value (struct_id) in the query focus table (query_focus)), code is added 602 to join with aliases for the connection table (dim_conn) and the query focus table (query_focus). When all the focused dimensions have been gone through in this manner, each grouped dimension (i.e. each structural identity (struct_id) value in the query group table (query_group) is gone through, and code is added 603 to join with an alias for the query group table (query_group) and to select and group by group identifier (group_id) and group presentation name (group_pres_name).

When this process is completed, the following SQL code will result:

SELECT

| | |
|---|---|
| O_query_group.group_id, O_query_group.group_pres_name, | /* (603) */ |
| A_query_group.group_id, A_query_group.group_pres_name, | /* (603) */ |
| SUM(data_value.data_value) | /* (601) */ |

FROM

| | |
|---|---|
| location, data_value, | /* (601) */ |
| query_focus O_query_focus, dim_conn O_dim_conn, | /* (602) */ |
| query_group O_query_group, | /* (603) */ |
| query_focus A_query_focus, dim_conn A_dim_conn, | /* (602) */ |
| query_group A_query_group | /* (603) */ |

WHERE

| | |
|---|---|
| location.location_id = data_value.location_id | /* (601) */ |
| AND | |

| | |
|---|---|
| (O_query_focus.struct_id = ‘O’ AND | /* (602) */ |
| O_dim_conn.dim_item_id = O_query_focus.focus_dim_item_id AND | /* (602) */ |
| location.location_id = O_dim_conn.location_id AND | /* (602) */ |
| O_query_group.struct_id = O_query_focus.struct_id AND | /* (603) */ |
| O_query_group.sel_dim_item_id = O_query_focus.sel_dim_item_id) | /* (603) */ |

AND

| | |
|---|---|
| (A_query_focus.struct_id = ‘A’ AND | /* (602) */ |
| A_dim_conn.dim_item_id = A_query_focus.focus_dim_item_id AND | /* (602) */ |
| location.location_id = A_dim_conn.location_id AND | /* (602) */ |
| A_query_group.struct_id = A_query_focus.struct_id AND | /* (603) */ |
| A_query_group.sel_dim_item_id = A_query_focus.sel_dim_item_id) | /* (603) */ |

GROUP BY

| | |
|---|---|
| O_query_group.group_id, O_query_group.group_pres_name, | /* (603) */ |
| A_query_group.group_id, A_query_group.group_pres_name | /* (603) */ |

The comments at the end of each line refer to the diagram in FIG. 6.

When a query is performed it is desirable to avoid repeated searches through large tables. In a worst case scenario the workload will increase proportionally with the length of the table and exponentially with the number of dimensions specified in the query. According to the first example the dimensional item table (dim_item) and the dimensional hierarchy table (dim_hier) must be processed once for each dimension specified in the query. By extracting the relevant information from these tables in advance, in accordance with the invention, the workload is reduced since the normally much shorter query tables (query_focus, query_group) are substituted for the dimensional item table (dim_item) and the dimensional hierarchy table (dim_hier).

Of course, if the majority of the items belong to a single dimension, and the user makes a selection that causes most of the items from that dimension to be within focus, the size of the query focus table (query_focus) will reach a limit where the performance gain diminishes. In such events it is however easy to extend the method with decisions on which search strategy to apply for the individual dimensions specified in the focus. The result would be a mixed-mode query utilizing the query focus table (query_focus) for dimensions with a limited number of focused items, while joining directly with dimensional item table (dim_item) and the dimensional hierarchy table (dim_hier) for dimensions where the number of focused items is large.

In a test performed by the applicant, a number of queries focusing on the same dimensions were performed. Four queries were based on traditional joins with the complete tables of the database, in this case the dimensional hierarchy table (dim_hier) and the dimensional item table (dim_item), and five were based on joins with aliases for the working tables described above (query_focus, query_group). The following table shows the results for completing the various queries.

| | | |
|---|---|---|
| Number of | Query with | Query with |
| dimensions | join towards | join towards |
| selected for | aliases for | aliases for |
| focusing and | dim_hier and | query_focus |
| grouping | dim_item | and query_group |

| | | | |
|---|---|---|---|
| 2 | 17 | seconds | 19 seconds |
| 3 | 37 | seconds | 19 seconds |
| 4 | 9 | minutes | 20 seconds |
| | 57 | seconds | |
| 5 | 11 | hours | 22 seconds |
| | 14 | minutes | |

| | | |
|---|---|---|
| 6 | Not tested | 31 seconds |

This example clearly illustrates the advantages of the method according to the invention over traditional strategies for performing such queries.

A data value's dimension membership may also be viewed as an attribute of the data value, to be retrieved for reporting purposes. Consider an example where focusing has only been made for the Organization dimension, but where the report shall present the results also by their account. Then, no rows relating to the structural identifier (struct_id) ‘A’ will be inserted into the working tables (query_focus, query_group). The generated code will then look like (lines changed from the previous example have been highlighted):

SELECT

O_query_group.group_id, O_query_group.group_pres_name,
A_dim_item.dim_item_id, A_dim_item.dim_item_name,
SUM(data_value.data_value)

FROM

location, data_value,
query_focus O_query_focus, query_group O_query_group, dim_conn O_dim_conn,
dim_item A_dim_item,
dim_conn A_dim_conn

WHERE

location.location_id = data_value.location_id
AND

(O_query_focus.struct_id = ‘O’ AND
O_dim_conn.dim_item_id = O_query_focus.focus_dim_item_id AND
location.location_id = O_dim_conn.location_id AND
O_query_group.sel_dim_item_id = O_query_focus.sel_dim_item_id)

AND

(A_dim_item.dim_type_id = ‘A’ AND
A_dim_conn.dim_item_id = A_dim_item.dim_item_id AND
location.location_id = A_dim_conn.location_id)

GROUP BY

O_query_group.group_id, O_query_group.group_pres_name,
A_dim_item.dim_item_id, A_dim_item.dim_item_name

New dimensions may be added to the model to impose alternative perspectives on existing dimensions. Such a dimension will be referred to as an analysis dimension.

The purpose of an analysis dimension may be two-fold. Firstly it is a means to easily select related items that are scattered throughout different branches in a dimension tree. Secondly it provides a means to generate reports aggregating data into groups that are not explicitly expressed as items in the original dimension

To make a dimension accessible through an analysis dimension, it is necessary to perform some preparations. One alternative way to perform this according to a preferred embodiment of the invention is described below. A connection type that represents ‘identity’ is defined (unless it is already defined). Also, a connection type representing ‘analysis connection’ is defined (unless already defined). These are entered as new rows in the connection type table (dim_conn_type). In addition a location type representing ‘identity’ is defined (unless already defined) and entered into the location type table (location_type). Finally locations corresponding one-to-one to the items that are to be accessed through the analysis dimension are inserted and connected to the corresponding items with connections of the ‘identity’ type.

The result of these steps is the creation of locations that are connected to only one dimensional item in only one dimension each, and hence positioned as locations in the multi-dimensional space along the axis defined by the dimension they belong to. In this way they form the basis for further specification of their location along new axes defined by analysis dimensions, making it possible to indirectly connect items in analysis dimensions to regular dimensional items.

The items in an analysis dimension are referred to as analysis items. A regular dimension containing items to be connected to analysis items, is referred to as a target dimension. The introduction of a new analysis dimension involves adding a new dimensional type in the dimensional type table (dim_type), adding zero or more dimensional item types in the dimensional item type table (dim_item_type) to differentiate the analysis items (if necessary), adding new dimensional item entries belonging to the analysis dimension in the dimensional item table (dim_item) and specifying the hierarchical relations between the analysis items as new entries in the dimensional hierarchy table (dim_hier) if the analysis dimension is hierarchical.

Applying the analysis dimension to a target dimension, involves connecting items in the target dimension to analysis items. Provided the alternative described above has been chosen, this involves the insertion of new rows in the connection table (dim_conn) to connect locations representing items from the target dimension to the desired analysis items from the analysis dimension. The connection type representing ‘analysis connection’ will be used. In this way the items of the analysis dimensions are associated with items of the target dimensions by being connected to the locations that were created to represent these target dimension items.

The concept of analysis dimensions will be further explained by way of examples. Reference is made to FIG. 7, illustrating the introduction of an analysis dimension to facilitate selection of organizational units for reporting purposes. The dimension should make it possible to produce a weekly report summarizing the status within sales and accounting, while a similar report for production and personnel should be produced on a monthly basis. To facilitate this, a new analysis dimension, Reporting, is introduced. This dimension includes two analysis items weekly and monthly. (It should be noted that there is no time dependency associated with these dimensions or the queries described below, and the items could have any other name if so desired.)

Several analysis dimensions may be introduced and applied to the same target dimension. FIG. 8 illustrates an additional analysis dimension, Function, facilitating reports summarizing the information into the categories external and internal, depending on the main function of the various organizational units.

After the addition of the two analysis dimensions mentioned above, the following rows will be added to the tables holding the model:

Table dim_type

| dim_type_id | dim_type_name |
|---|---|
| R | Reporting |
| F | Function |

Table dim_item_type

| dim_item_type_id | dim_item_type_name |
|---|---|
| A | Analysis item |

Table dim_item

| dim_item_id | dim_item_name | dim_type_id | dim_item_type_id |
|---|---|---|---|
| 3001 | Reporting | R | A |
| 3002 | weekly | R | A |
| 3003 | monthly | R | A |
| 4001 | Function | F | A |
| 4002 | external | F | A |
| 4003 | internal | F | A |

Table dim_hi r

| super_dim_item_id | sub_dim_item_id | distance |
|---|---|---|
| 3001 | 3001 | 0 |
| 3001 | 3002 | 1 |
| 3001 | 3003 | 1 |
| 3002 | 3002 | 0 |
| 3003 | 3003 | 0 |
| 4001 | 4001 | 0 |
| 4001 | 4002 | 1 |
| 4001 | 4003 | 1 |
| 4002 | 4002 | 0 |
| 4003 | 4003 | 0 |

Table location_type

| location_type_id | location_type_name |
|---|---|
| LI | Identity |

Table location

| location_id | location_type_id |
|---|---|
| 11002 | LI |
| 11003 | LI |
| 11005 | LI |
| 11006 | LI |

Table dim_conn_type

| dim_conn_type_id | dim_conn_type_name |
|---|---|
| I | Identity |
| A | Analysis connection |

Table dim_conn

| location_id | dim_item_id | dim_conn_type_id |
|---|---|---|
| 11002 | 1002 | I |
| 11003 | 1003 | I |
| 11005 | 1005 | I |
| 11006 | 1006 | I |
| 11002 | 3002 | A |
| 11005 | 3002 | A |
| 11003 | 3003 | A |
| 11006 | 3003 | A |
| 11002 | 4002 | A |
| 11003 | 4002 | A |
| 11005 | 4003 | A |
| 11006 | 4003 | A |

It should be noted that the choice to represent the connections to analysis dimensions using the location table (location) and the connection table (dim_item_conn) is implementation dependent. It is made out of convenience, and to illustrate the flexibility offered by the data model with respect to addition of new dimensions. The main purpose of an analysis dimension is to offer an alternative perspective on the items contained in a dimension. There are examples of other systems offering dynamic addition of dimensions, but this is usually achieved by connecting the data directly to the new dimension. Although this is also possible using the data model of the invention, the approach of analysis dimensions has some advantages: The systems loading data into the model need not know about the analysis dimensions, since there is no need to connect new data locations directly to the analysis items. The number of rows added to the model is usually smaller since the number of items affected is generally an order of magnitude smaller than the number of locations.

The criteria for selection of items from the target dimension may be expressed by simultaneous selections in multiple analysis dimensions.

When items from a target dimension shall be identified through the use of analysis dimensions, the following information will be available. Specifications of focus in one or more analysis dimensions, each consisting of a list of selected items from the analysis dimension and a specification of the generality of the focus (e.g. whether items connected to descendants of the selected analysis items should be considered to be within focus), the dimensional type identifier (dim_type_id) of the target dimension, and optionally other restrictions, e.g. specific item type identifiers (item_type_id) of interest in the target dimension.

This information is referred to as an analysis focus specification, and it is similar to the query focus specification available to the search algorithm described above. Thus, the search can be carried out in a similar manner, yielding a list of dimensional item identifiers (dim_item_id). These dimensional items identifiers in turn, will be used as explicitly selected items when querying the database for the actual data values Thus, an analysis focus specification may be viewed as an extension to a dimensional focus specification, which will be processed at the beginning of the process of preparing data in the working tables (query_focus) and (query_group).

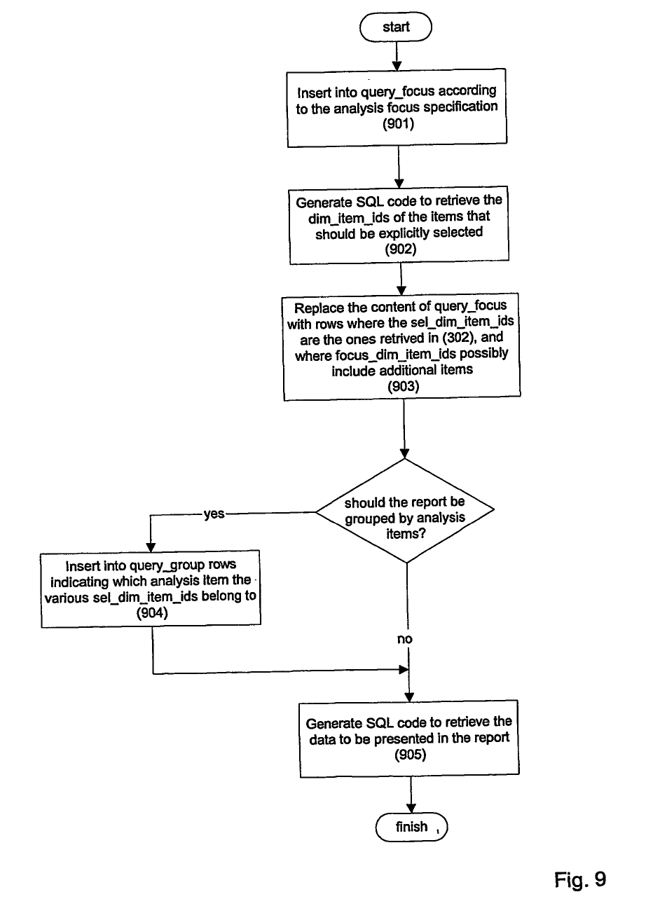

Reference is made to FIG. 9 in the following example, which illustrates the selection of the organizational units that should report weekly, and the production of a report summarizing the information into the categories external and internal. The process of retrieving the data to be presented in this report would include the following steps:

First, rows are inserted 901 into the query focus table (query_focus) according to the analysis focus specification, i.e. ‘with weekly reporting, and with internal or external function’.

Following that, SQL code to retrieve the dimensional item identifiers (dim_item_id) of the items that should be selected 902 for the report is generated, along with their membership in the branches for external or internal. This code is executed to retrieve the list of explicitly selected items for the report, along with information to be used to specify grouping of the explicitly selected items into the groups defined by the analysis items they are (implicitly) connected to.

Then the content of the query focus table (query_focus) is replaced 903 with rows where the explicitly selected item identifiers (sel_dim_item_id) are the dimensional item identifiers retrieved by the above query, and where the focused item identifiers (focus_dim_item_id) may include additional items (e.g. descendants), depending on the generality of the dimensional focus specification.

Next, rows are inserted 904 into the query group table (query_group) indicating which analysis item (internal or external) the various selected item identifiers (sel_dim_item_id) in the query focus table (query_focus) belong to. The names of the analysis items should be included as well.

Finally the SQL code to retrieve 905 the data to be presented in the report is generated.

The results of these steps are described in more detail below:

The table (query_focus) is filled with rows according to the analysis focus specification.

Results from the First Step (901):

Table query_focus

| struct_id | sel_dim_item_id | focus_dim_item_id |
|---|---|---|
| R | 3002 | 3002 |
| F | 4002 | 4002 |
| F | 4003 | 4003 |

Then, SQL code is generated and executed to retrieve the dimensional item identifiers to be explicitly selected for the report, along with membership in the branches for external and internal. (The example shows one simple way of generating such code. Other schemes may work equally well.)

Results from the Second Step (902):

SELECT

/* Retrieve dim_item_id of items to be selected for the report: */
I_dim_conn.dim_item_id,
/* Retrieve membership in branches for <external, internal>: */
F_query_focus.sel_dim_item_id, F_dim_item.dim_item_name

FROM

location,
dim_conn I_dim_conn,
query_focus R_query_focus, dim_conn R_dim_conn,
query_focus F_query_focus, dim_conn F_dim_conn,
dim_item F_dim_item

WHERE

location.location_id = I_dim_conn.location_id AND I_dim_conn.dim_conn_type_id = ‘I’
AND

(R_query_focus.struct_id = ‘R’ AND R_dim_conn.dim_conn_type_id = ‘A’ AND
R_dim_conn.dim_item_id = R_query_focus.focus_dim_item_id AND
location.location_id = R_dim_conn.location_id)

AND

(F_query_focus.struct_id = ‘F’ AND F_dim_conn.dim_conn_type_id = ‘A’ AND
F_dim_conn.dim_item_id = F_query_focus.focus_dim_item_id AND
location.location_id = F_dim_conn.location_id AND
/*Join with dim_item to retrieve textual representation of <external,internal>: */
F_dim_item.dim_item_id = F_query_focus.sel_dim_item_id)

The query focus table (query_focus) is filled with rows corresponding to the items returned by the query above.

Results from the Third Step (903):

Table query_focus

| struct_id | sel_dim_item_id | focus_dim_item_id |
|---|---|---|
| O | 1002 | 1002 |
| O | 1005 | 1005 |

The query group table (query_group) is filled with rows to group explicitly selected items into the categories external and internal. In this simple example there are only one explicitly selected item mapped into each group, but in general there may be several.

Results from the Fourth Step (904):

Table query_group

| struct_id | sel_dim_item_id | group_id | group_pres_name |
|---|---|---|---|
| O | 1002 | 4002 | external |
| O | 1005 | 4003 | internal |

Then, SQL code is generated and executed to retrieve actual data to be displayed in the report. This follows the exact procedure described previously.

Results from the Fifth Step (905):

SELECT

O_query_group.group_id, O_query_group.group_pres_name,
SUM(data_value.data_value)

FROM

location, data_value,
query_focus O_query_focus, dim_conn O_dim_conn,
query_group O_query_group

WHERE

location.location_id = data_value.location_id
AND

(O_qu ry_focus.struct_id = ‘O’ AND
O_dim_conn.dim_item_id =
O_query_focus.focus_dim_item_id AND
location.location_id = O_dim_conn.location_id
AND
O_query_group.struct_id =
O_query_focus.struct_id AND
O_query_group.sel_dim_it m_id =
O_query_focus.sel_dim_item_id)

GROUP BY

O_query_group.group_id, O_query_group.group_pres_name

It is possible to let a regular dimension take on the role of an analysis dimension towards another regular dimension. To facilitate this, it is necessary to introduce a new connection type, and use this to make the connections relating to the use of the dimension as an analysis dimension distinguishable from the connections related to regular use of the dimension. By introducing several connection types, it is even possible to apply the same dimension (analysis dimension or regular dimension) as several analysis dimensions towards the same regular dimension.

It must be understood that the embodiment described above is exemplary only, and not limiting on the scope of the invention.

The invention will be useful in implementing computerized functions for business intelligence and decision support. In these areas the ability to view information categorized and aggregated according to multiple dimensions is crucial. Demands for different perspectives on the information are common, partly to be able to provide consistent views on information extracted from data sources with different categorization of the data, and partly to explore structures that are not explicitly expressed in the source data. The invention provides means to satisfy such demands without the need to change the underlying database schema, or to modify the core programs acting on that schema.

A data warehouse is often found as part of the infrastructure underlying a business intelligence solution spanning multiple data sources (e.g. transactional systems like accounting systems) and/or organizations (e.g. companies within a corporation). The task of the data warehouse is to reliably import data from the data sources, ensure that the quality of that data meets the standards specified, and represent the data in a single consistent database. It is common that systems acting on data from a data warehouse take on the form of data marts. The task of a data mart is to extract the relevant subset of data from the data warehouse, and provide end-user with functions on that data. These functions can range from sophisticated on-line analytical processing (OLAP) and data-mining, to production of paper-based reports.

Data warehouses are becoming commonplace, and the demand for data marts tailored to specific needs is increasing. The invention provides the basis for implementing a customizable data mart that can meet a lot of different requirements without the need for additional data modeling or programming. The inherent flexibility of the model underlying the invention makes it easy to implement required changes, such as the introduction of new dimensions or measures, without the help of skilled computer professionals. This greatly reduces the lifetime cost of the data mart. The concepts of item types, connection types, location types and analysis dimensions provides a basis for expressing complex business logic, which in turn can be interpreted by generic report implementations to create reports that match the business requirements more closely than what is achieved by generalized OLAP-tools.

Many present systems within specific domains, for instance customer relationship management (CRM), face an increasing demand for built-in business intelligence support. These systems are usually built on relational database technology. Since the invention builds directly on relational database technology, the threshold is low for integrating the data model and methods of the invention into such systems. This provides a good opportunity for vendors of such systems to meet the increased business intelligence demands in a tightly integrated manner.

The data model and methods of the invention could be implemented and packaged as a framework for integration in other systems, e.g. in the form of an object oriented library implemented in a programming language like Java or C++. The availability of such a library of proven quality would make the invention attractive to any project implementing a system based on a multi-dimensional model. Such a framework could even prove useful in the implementation of new data warehouses.

Since the invention builds directly on a relational database platform, the integration of transactional data-entry functions into a system based on the invention will generally be easier than with a system built on a multi-dimensional database management system. This may for instance be utilized to extend a read-only business intelligence solution with functions to initiate, plan and follow up corrective actions based on exceptions flagged in the underlying data.

Vendors of relational database management systems may find it useful to integrate the data model and methods of the invention in the offering to their customers. Being in control of the core components of the database management system, such a vendor may provide an implementation with improved performance, for instance by treating the working tables specially. The techniques described in the methods of the invention may even be handled by having the query optimizer transform more simple-minded queries into queries that apply these methods.

1. Method for structuring data in a computerized relational database system comprising a storage device (5) for storing the relational database in the form of a number of tables, at least one central processor (1) connected to said storage device (5), and a database manager (3) comprising instructions capable of making the processor perform queries on said database, characterized by the steps of
generating a dimension type table (dim_type) of descriptions of the dimensions present in the database, each row of which including at least a dimension identifier (dim_type_id) and a dimension name (dim_type_name),
generating a dimensional item table (dim_item) of dimensional items, each row of which including at least an internal item identifier (dim_item_id), a presentation name (dim_item_name), and an identifier of a dimensional description (dim_type_id) in said dimension type table,
generating a location table (location) of locations representing intersection points between the various dimensions, each row of which including at least a location identifier (location_id), and
generating a connection table (dim_conn) defining connections between each location and dimensional items with which they are associated, each row of which including at least a location identifier (location_id) and a dimensional item identifier (dim_item_id)

2. Method according to claim 1, characterized in that it further comprises the step of generating a hierarchy table (dim_hier) defining dimensional hierarchies, each row of which including at least the identifier of an ancestor item (super_dim_item_id) in said dimensional item table (dim_item), the identifier of a descendant item (sub_dim_item_id) in said dimensional item table (dim_item), and the distance between the two items as number of hierarchical levels (distance), each item in said dimensional item table being defined as its own ancestor with distance zero.

3. Method according to claim 1 or 2, characterized in that each row of said location table (location) further includes one or more numeric or alphanumeric data values.

4. Method according to claim 1, characterized in that it further comprises the step of generating a data value table (data_value) of data contained in the database, each row of which including at least a location identifier (location_id) and a numeric or alphanumeric data value.

5. Method according to claim 1, characterized in that it further comprises the step of generating a dimensional item type table (dim_item_type) of descriptions of types that may be used in classification of items belonging to the same dimension, each row of which including at least an item type identifier (dim_item_type_id) and an item type name (dim_item_type_name); and that each row of said dimensional item table (dim_item) further includes the identifier of an item type (dim_item_type_id) in said dimensional item type table (dim_item_type).

6. Method according to claim 1, characterized in that it further comprises the step of generating a connection type table (dim_conn_type) of definitions of different semantics that may be associated with a connection between a location and an item in a dimension, each row of which at least including a connection type identifier (dim_conn_type_id) and a connection type name (dim_conn_type_name); and that each row of said connection table (dim_conn) further includes the identifier of a connection type (dim_conn_type_id) in said connection type table (dim_conn_type).

7. Method according to one of the claim 1, characterized in that it further comprises the step of generating a location type table (location_type) of classifications of locations in said location table (location), each row of which at least including a location type identifier (location_type_id) and a location type name (location_type_name); and that each row of said location table (location) further includes the identifier of a location type (location_type_id) in said location type table (location_type).

8. Computerized database system comprising a storage device (5) upon which is stored a relational database in the form of a number of tables, at least one central processor (1) connected to said storage device (5), and a database manager (3) comprising instructions capable of making the processor perform queries on said database, characterized by said tables including
a dimension type table (dim_type) of descriptions of the dimensions present in the database, each row of which including at least a dimension identifier (dim_type_id) and a dimension name (dim_type_name),
a dimensional item table (dim_item) of dimensional items, each row of which including at least an internal item identifier (dim_item_id), a presentation name (dim_item_name), and an identifier of a dimensional description (dim_type_id) in said dimension type table,
a location table (location) of locations representing intersection points between the various dimensions, each row of which including at least a location identifier (location_id), and
a connection table (dim_conn) defining connections between each location and dimensional items with which they are associated, each row of which including at least a location identifier (location_id) and a dimensional item identifier (dim_item_id).

9. System according to claim 8, characterized in that it further comprises a hierarchy table (dim_hier) defining dimensional hierarchies, each row of which including at least the identifier of an ancestor item (super_dim_item_id) in said dimensional item table (dim_item), the identifier of a descendant item (sub_dim_item_id) in said dimensional item table (dim_item), and the distance between the two items as number of hierarchical levels (distance), each item in said dimensional item table being defined as its own ancestor with distance zero.

10. System according to claim 8 or 9, characterized in that each row of said location table (location) further includes one or more numeric or alphanumeric data values.

11. System according to claim 8, characterized in that it further comprises a data value table (data_value) of data contained in the database, each row of which including at least a location identifier (location_id) and a numeric or alphanumeric data value.

12. System according to claim 8, characterized in that it further comprises a dimensional item type table (dim_item_type) of descriptions of types that may be used in classification of items belonging to the same dimension, each row of which including at least an item type identifier (dim_item_type_id) and an item type name (dim_item_type_name); and that each row of said dimensional item table (dim_item) further includes the identifier of an item type (dim_item_type_id) in said dimensional item type table (dim_item_type).

13. System according to claim 8, characterized in that it further comprises a connection type table (dim_conn_type) of definitions of different semantics that may be associated with a connection between a location and an item in a dimension, each row of which at least including a connection type identifier (dim_conn_type_id) and a connection type name (dim_conn_type_name); and that each row of said connection table (dim_conn) further includes the identifier of a connection type (dim_conn_type_id) in said connection type table (dim_conn_type).

14. System according to claim 8, characterized in that it further comprises a location type table (location_type) of classifications of locations in said location table (location), each row of which at least including a location type identifier (location_type_id) and a location type name (location_type_name); and that each row of said location table (location) further includes the identifier of a location type (location_type_id) in said location type table (location_type).

15. Method for performing a computerized query in a relational database, where the database at least includes a dimension type table (dim_type) of dimensional types, a dimensional item table (dim_item) of dimensional items, a location table (location) of locations representing intersection points between the various dimensions, and a connection table (dim_conn) defining connections between each location and dimensional items with which they are associated, characterized by the steps of
specifying a query focus specification defining the subset of the database that the query should retrieve its results from consisting of a list of dimensional focus specifications, each specifying rules to identify a subset of dimensional items from one dimension of the database,
generating a first working table defining a query focus (query_focus), each row of which including a structural identifier (struct_id) identifying the dimensional focus specification the row belongs to, a focused item identifier (focus_dim_item_id) identifying an item in said dimensional item table (dim_item) of dimensional items that is in the query focus, and
performing a query in said relational database based on the focus defined in said first working table (query_focus), collecting data associated with locations connected to at least one of the focused items (focus_dim_item_id) identified for each structural identifier (struct_id) defined by the dimensional focus specifications contained in the query focus specification.

16. Method according to claim 15, characterized in that the step of specifying a query focus specification includes specifying for any given dimensional focus specification rules to directly or indirectly retrieve a list of explicitly selected item identifiers,
that the step of generating said first working table (query_focus) includes using an additional column for an explicitly selected item identifier (sel_dim_item_id) identifying an item in said dimensional item table (dim_item) of dimensional items that caused the item identified by the focused item identifier (focus_dim_item_id) to be considered part of the focus,
generating a second working table of query groups (query_group) defining groups that the data resulting from the query should be aggregated by each row of which including
a structural identifier (struct_id) and an explicitly selected item identifier (sel_dim_item_id) identifying rows in said first working table (query_focus) that should be included in the group,
a group identifier (group_id) that identifies the group, and
a group presentation name (group_pres_name) that gives the name to be used when presenting the group in the results of the aggregated query, and
that the step of performing a query in said relational database includes aggregating the results of the query according to the groups defined in said second working table (query_group).

17. Method according to claim 15 or 16, characterized in that the step of specifying a query focus specification includes specifying for any given dimensional focus specification, a list of explicitly selected item identifiers and a specification of generality of focus expressed as a number of ascendant and/or descendant hierarchical levels, and
that the step of generating said first working table for any given dimensional focus specification includes using a hierarchy table (dim_hier) defining dimensional hierarchies to determine the set of focused item identifiers (focus_dim_item_id) based on said list of explicitly selected item identifiers, and said specification of generality of focus.

18. Method according to claim 15, characterized in that the step of generating said first working table (query_focus) includes using a dimensional item type table (dim_item_type) describing types that may be used in classification of items belonging to the same dimension, to limit the set of focused item identifiers (focus_dim_item_id) identified for any given structural identifier (struct_id).

19. Method according to claim 15, characterized in that the step of performing said query includes using a connection type table (dim_conn_type) of definitions of different semantics that may be associated with connections between locations and items in a dimension, to collect data associated with locations connected with specific connection types (dim_conn_type_id) to at least one of the focused items (focus_dim_item_id) identified for any given structural identifier (struct_id).

20. Method according to claim 15, characterized in that the step of performing said query includes using a location type table (location_type) of classifications of locations in said location table (location), to collect data associated with locations with specific location types (dim_conn_type_id).

21. Method according to claim 15, characterized in that the step of generating said first working table (query_focus) includes iterating over the dimensional focus specifications contained in a given query focus specification and for each dimensional item determined to be in focus entering in the first working table (query_focus) a row containing,
the identification of the dimensional focus specification as a structural identifier (struct_id),
the dimensional item identifier (dim_item_id) of the item as said focused item identifier (focus_dim_item_id).

22. Method according to claim 16 characterized in that the step of generating said first working table (query_focus) includes iterating over the dimensional focus specifications contained in a given query focus specification and for each dimensional item determined to be in focus entering in the first working table (query_focus) a row containing,
the identification of the dimensional focus specification as a structural identifier (struct_id),
the dimensional item identifier (dim_item_id) of the item as said focused item identifier (focus_dim_item_id)
the dimensional item identifier (dim_item_id) of the dimensional item that caused said dimensional item to be in focus as said explicitly selected item identifier (sel_dim_item_id).

23. Method according to claim 22,
characterized in that each step of entering rows in said first working table is followed by a step determining whether the query result should be grouped by the explicitly selected items or some categorization of these, and if so, entering rows in the second working table (query_group) each row containing
the identification of the dimensional focus specification as said structural identifier (struct_id) and the dimensional item identifier (dim_item_id) of the explicitly selected item as said explicitly selected item identifier (sel_dim_item_id) as the two identifiers identifying rows in said first working table (query_focus),
a unique group identifier (group_id), and
a group presentation name (group_pres_name).

24. Method according to claim 23, characterized in that said group identifier (group_id) is the same as said explicitly selected item identifier (sel_dim_item_id).

25. Method according to claim 23, characterized in that said group identifier (group_id) is generated based on a categorization of the explicitly selected items.

26. Method according to claim 15, characterized in that said dimension type table (dim_type) contains one or more rows defining analysis dimensions,
that said dimensional item table (dim_item) contains one or more rows defining analysis items belonging to said analysis dimensions,
that the database contains definitions of connections between items in said analysis dimensions and items belonging to regular dimensions, and
that the step of specifying a query focus specification for any given dimensional focus specification on a regular dimension includes specifying an analysis focus specification consisting of a list of dimensional focus specifications on analysis dimensions, each specifying rules to identify a subset of analysis items from an analysis dimension.

27. Method according to claim 22, characterized in that said dimension type table (dim_type) contains one or more rows defining analysis dimensions,
that said dimensional item table (dim_item) contains one or more rows defining analysis items belonging to said analysis dimensions,
that the database contains definitions of connections between items in said analysis dimensions and items belonging to regular dimensions, and
that said dimensional focus specification contains an analysis focus specification consisting of a list of dimensional focus specifications on analysis dimensions, each specifying rules to identify a subset of analysis items from an analysis dimension, and
that the list of explicitly selected items for a dimensional focus specification is retrieved from the database by applying said analysis focus specification.

28. Method according to claim 23, characterized in that said dimension type table (dim_type) contains one or more rows defining analysis dimensions,
that said dimensional item table (dim_item) contains one or more rows defining analysis items belonging to said analysis dimensions,
that the database contains definitions of connections between items in said analysis dimensions and items belonging to regular dimensions, and
that said dimensional focus specification contains an analysis focus specification consisting of a list of dimensional focus specifications on analysis dimensions, each specifying rules to identify a subset of analysis items from an analysis dimension, and
that the step of entering rows in second working table (query_group) generates group identifiers (group_id) and group presentation names (group_pres_name) by retrieving from the database information about analysis items connected to the explicitly selected items identified by applying said analysis focus specification.

29. Method for performing a computerized query in a relational database systems, where the database at least includes a dimension type table (dim_type) of dimensional types, a dimensional item table (dim_item) of dimensional items, a location table (location) of locations representing intersection points between the various dimensions, and a connection table (dim_conn) defining connections between each location and dimensional items with which they are associated, characterized by the steps of
entering in said dimension type table (dim_type) one or more rows defining analysis dimensions,
entering in said dimensional item table (dim_item) one or more rows defining analysis items belonging to said analysis dimensions,
defining connections between items in said analysis dimensions and items belonging to regular dimensions, and
performing queries that limit and/or aggregate results according to specifications on the analysis dimensions.

30. Method according to claim 29, characterized in using a hierarchy table (dim_hier) defining dimensional hierarchies within analysis dimensions that are hierarchical.

31. Method according to claim 29 or 30, characterized in that said connections between items in said analysis dimensions and items in other dimensions are defined by
entering in a location type table (location_type) containing classifications of locations in said location table (location), a row that defines identity,
entering in said location table (location) rows representing one-to-one each item in any regular dimension that are to be accessed through the analysis dimension, each such row also referring to the entry in said location type table (location_type) defining identity,
entering in said connection table (dim_conn) one row for each connection between a location in said location table (location) and the regular dimensional item it represents in said dimensional item table (dim_item),
entering in said connection table (dim_conn) one row for each connection between a location in said location table (location) representing an item in a regular dimension and an item belonging to an analysis dimension in said dimensional item table (dim_item).

32. Method according to claim 31,
of using a first regular dimension as an analysis dimension towards a second regular dimension characterized in
generating a connection type table (dim_conn_type) of definitions of different semantics that may be associated with a connection between a location and an item in a dimension; and that each row of said connection table (dim_conn) further includes the identifier of a connection type in said connection type table (dim_conn_type),
entering in said connection type table (dim_conn_type) one or more rows representing connection types indicating the use of said first regular dimension as an analysis dimension towards said second regular dimension,
entering in said connection table (dim_conn) one row for each connection between a location in said location table (location) representing an item in said second regular dimension and an item belonging to said first regular dimension dimension in said dimensional item table (dim_item).

33. Computer program product comprising instructions for, when loaded into and executed by a computer, causing the computer to perform the method of claim 1.

34. Computer program according to claim 33, embodied on a record medium.

35. Computer program according to claim 33, stored in a computer memory.

36. Computer program according to claim 33, carried on an electrical or optical carrier signal.

37. Computer program product comprising instructions for, when loaded into and executed by a computer, causing the computer to perform the method of claim 15.

38. Computer program according to claim 37, embodied on a record medium.

39. Computer program according to claim 37, stored in a computer memory.

40. Computer program according to claim 37, carried on an electrical or optical carrier signal.

41. Computer program product comprising instructions for, when loaded into and executed by a computer, causing the computer to perform the method of claim 28.

42. Computer program according to claim 41, embodied on a record medium.

43. Computer program according to claim 41, stored in a computer memory.

44. Computer program according to claim 41, carried on an electrical or optical carrier signal.
